(19) United States
(12) Patent Application Publication
(10) Pub. No.: US 2023/0320923 A1
(43) Pub. Date: Oct. 12, 2023

(54) HUMAN BODY MASSAGE DEVICE

(71) Applicant: Guangzhou Pinai Technology Co., Ltd., Guangzhou (CN)

(72) Inventor: Yaqin WU, Guangzhou (CN)

(73) Assignee: Guangzhou Pinai Technology Co., Ltd., Guangzhou (CN)

(21) Appl. No.: 17/738,235

(22) Filed: May 6, 2022

(30) Foreign Application Priority Data
Apr. 12, 2022 (CN) 202220839982.3

(51) Int. Cl. A61H 7/00

(52) U.S. Cl. CPC A61H 7/004; A61H 2201/0207; A61H 2201/0221; A61H 2201/1207; A61H 2201/1664

(57) ABSTRACT

Disclosed is a human body massage device, comprising: a main housing provided with a first movable cavity; a massage body movably connected in the first movable cavity and movable from a first position of the first movable cavity to a second position thereof along an axial direction of the main housing; an outer support provided with a heating part for conducting heat to the massage body. The technical solution of the present application can improve the user's comfort.

### CROSS-REFERENCE TO RELATED APPLICATIONS

The present application claims priority to Chinese Patent Application No. 202220839982.3, filed on Apr. 12, 2022, titled “Human body massage device”, which is hereby incorporated for reference in its entirety for all purposes.

### TECHNICAL FIELD

The present application relates to the technical field of massage fitness device, in particular to a human body massage device.

### BACKGROUND

Massager is a general name of tools for massaging people's whole body or various parts of the body; it is a new generation of health care device developed according to physics, bionics, bioelectricity, traditional Chinese medicine and many years of clinical practice.

However, the existing human body massage device has low comfort, poor operation flexibility and poor user experience.

### SUMMARY

The main purpose of the present application is to propose a human body massage device, which aims to improve the user's comfort and be suitable for more different environments.

The present application provides a human body massage device, comprising:
a main housing provided with a first movable cavity;
a massage body movably connected in the first movable cavity and movable from a first position of the first movable cavity to a second position thereof along an axial direction of the main housing;
an outer support provided with a heating part for conducting heat to the massage body.

Optionally, the main housing comprises a first upper housing and a first lower housing detachably connected with each other; and the first upper housing and the first lower housing form a first movable cavity.

Optionally, the outer support comprises an outer support plate, and the heating part is connected to a side end of the outer support plate; the outer support plate is detachably connected to a side end of the main housing.

Optionally, the outer support is provided with a charging input part; the main housing is provided with a charging connection part and a battery; an output end of the charging connection part is electrically connected with an input end of the battery, and the battery is configured to supply power to the massage body; an output end of the charging input part is electrically connected with an input end of the charging connection part.

Optionally, the heating part comprises a heating sheet and a heat conducting rod; the heating sheet is circumferentially connected to an inner surface of the heat conducting rod, and a side end of the heat conducting rod is movable into the first movable cavity.

Optionally, the massage body comprises a massage inner pad, a placing housing and a driving assembly, and the massage inner pad is detachably connected inside the placing housing; the driving assembly is located in the first movable cavity and movably connected with the placing housing, such that the placing housing is movable from a first position to a second position.

Optionally, the driving assembly comprises a main driving motor, a pushing joint and a traction assembly; the traction assembly is connected with the placing housing; the main driving motor is connected in the first movable cavity and movably connected with a first end of the pushing joint, and a second end of the pushing joint is connected with a first end of the traction assembly; a second end of the traction assembly is movably connected with the traction assembly.

Optionally, the traction assembly comprises a sliding block, a sliding rail guide rod, a mounting cover body, a position information transmitting part and a position information receiving part; the mounting cover body is provided with a first placing inner cavity, and the first placing inner cavity is configured to mount the placing housing; the sliding rail guide rod is connected in the main housing; a first end of the sliding block is connected with the mounting cover body, and a second end of the sliding block is slidably connected with the sliding rail guide rod; the position information transmitting part is connected in the sliding block; the position information receiving part is connected in the main housing.

Optionally, further comprising a bottom support device provided with a swing assembly and a locking assembly, and the locking assembly is configured to connect with a base; a first end of the swing assembly is connected with the main housing, and a second end of the swing assembly is connected with the locking assembly, so that the main housing is swingable along the locking assembly.

Optionally, the swing assembly comprises a first support swing plate, a second support plate and a first locking assembly, a first end of the first support swing plate is detachably connected with the main housing, and a second end of the first support swing plate is swingably connected with a first end of the second support plate in an up-down direction; a second end of the second support plate is detachably connected with the locking assembly;

when the first support swing plate and the second support plate are at a first threshold included angle, the first locking assembly is locked with the first support swing plate and the second support plate respectively;

and/or, the locking assembly comprises a third support plate, a fourth support limit plate and a second locking part; a first end of the third support plate is detachably connected with the swing assembly; the fourth support limit plate is connected below the third support plate, and the third support plate and the fourth support limit plate form a locking cavity configured to connect with the base; the second locking part is movably connected with the third support plate and the fourth support limit plate respectively to adjust a volume of the locking cavity.

Advantages: the technical solution of the present application conducts heat to the massage body by the heating part in the outer support, so as to keep a certain amount of heat during the use of the massage body, so as to improve the user's comfort. At the same time, the massage body can flexibly move from the first position to the second position, so as to expand the massage cover area, thereby improving the user's comfort and being suitable for more different environments.

### BRIEF DESCRIPTION OF THE DRAWINGS

In order to more clearly explain the embodiments of the present application or the technical solutions in the prior art, the following will briefly introduce the drawings in the embodiments or the description of the prior art. It is obvious that the drawings in the following description are only some embodiments of the present application. For those skilled in the art, other drawings can be obtained according to the structure shown in these drawings without paying creative labor.

FIG. 1 is a structural view of an embodiment of a human body massage device according to the present application.

FIG. 2 is a structural view of an embodiment of the human body massage device according to the present application.

FIG. 3 is a sectional structural view of an embodiment of the human body massage device according to the present application.

FIG. 4 is a partial structural exploded view of an embodiment of the human body massage device according to the present application.

FIG. 5 is a partial structural exploded view of an embodiment of the human body massage device according to the present application.

FIG. 6 is a structural view of a bottom support device of an embodiment of the human body massage device according to the present application.

FIG. 7 is a structural view of a bottom support device of an embodiment of a human body massage device according to the present application.

FIG. 8 is a structural view of a first embodiment of a driving assembly of an embodiment of the human body massage device according to the present application.

FIG. 9 is a structural view of a second embodiment of the driving assembly of an embodiment of the human body massage device according to the present application.

FIG. 10 is a structural view of a third embodiment of the driving assembly of an embodiment of the human body massage device according to the present application.

FIG. 11 is a structural view of a fourth embodiment of the driving assembly of an embodiment of the human body massage device according to the present application.

FIG. 12 is a structural view of a fifth embodiment of the driving assembly of an embodiment of the human body massage device according to the present application.

### DETAILED DESCRIPTION OF THE EMBODIMENTS

The technical solution in the embodiment of the present application will be clearly and completely described below in combination with the attached drawings in the embodiment of the present application. Obviously, the described embodiments are only part of the embodiments of the present application, not all of the embodiments. Based on the embodiments of the present application, all other embodiments obtained by those skilled in the art without creative work belong to the scope of protection of the present application.

It should be noted that if the embodiment of the present application involves directional indication (such as up, down, left, right, front, back . . . ), the directional indication is only used to explain the relative position relationship and movement between components in a specific attitude. If the specific attitude changes, the directional indication will change accordingly.

In addition, if there is a description of “first”, “second” and the like in the embodiment of the present application, the description of “first”, “second” and the like is only for the purpose of description, and cannot be understood as indicating or implying its relative importance or implicitly indicating the number of indicated technical features. Thus, the features defined with “first”, “second” may include at least one of the features explicitly or implicitly. In addition, if “and/or” appears in the full text, its meaning includes three parallel solutions. Take “Aa and/or B” as an example, including solution A, or solution B, or both solution A and B. In addition, the technical solutions of various embodiments can be combined with each other, but it must be based on the realization of those skilled in the art. When the combination of technical solutions is contradictory or impossible, it shall be considered that the combination of technical solutions does not exist and is not within the protection scope of the present application.

The present application provides a human body massage device.

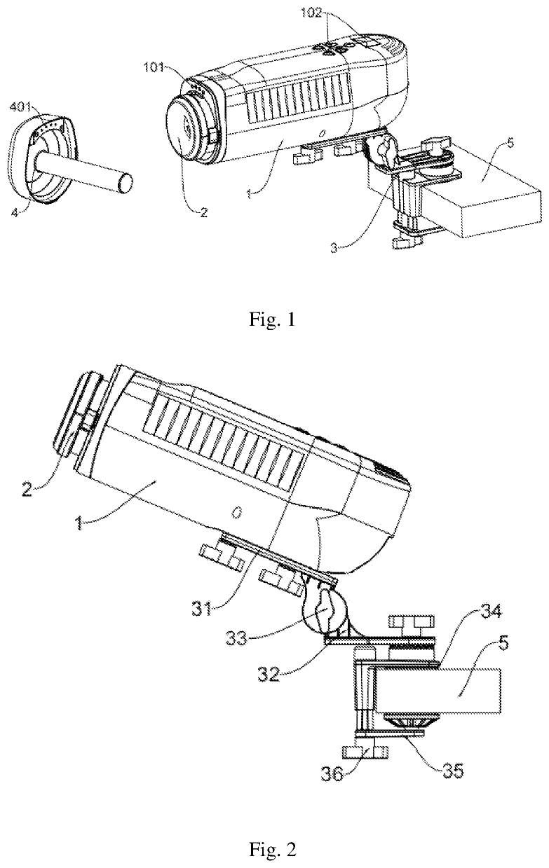

As shown in FIGS. 1, 2 and 3, in an embodiment of the present application, the human body massage device includes:
a main housing 1 provided with a first movable cavity;
a massage body 2 movably connected in the first movable cavity and movable from a first position of the first movable cavity to a second position thereof along an axial direction of the main housing 1;
an outer support 4 provided with a heating part for conducting heat to the massage body 2.

The technical solution of the present application conducts heat to the massage body by the heating part in the outer support, so as to keep a certain amount of heat during the use of the massage body, so as to improve the user's comfort. At the same time, the massage body can flexibly move from the first position to the second position, so as to expand the massage cover area, thereby improving the user's comfort and being suitable for more different environments.

In some embodiments, the first position and the second position are any position in the first movable cavity. In other words, the massage body can be telescopic and move back and forth in the first active cavity, so as to ensure the activity flexibility and the user's comfort.

Human body massage device can be configured to massage human fingers, arms and other parts.

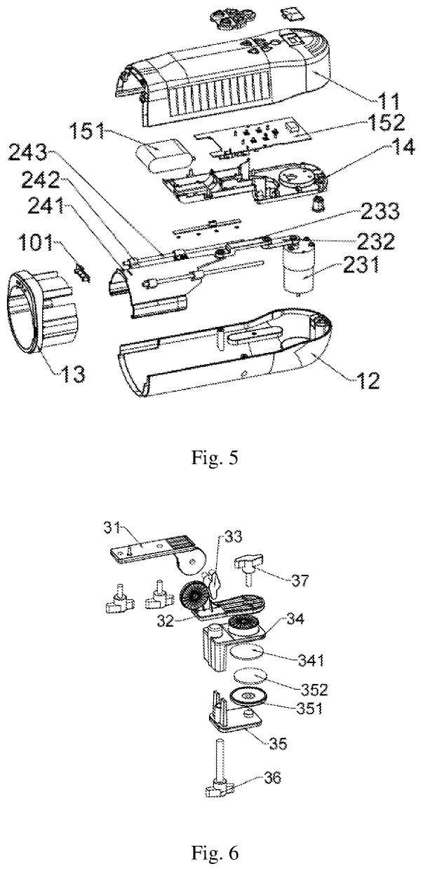

Specifically, in some embodiments, as shown in FIG. 5, the main housing 1 includes a first upper housing 11 and a first lower housing 12 detachably connected with each other; and a first upper housing 11 and a first lower housing 12 forms the first movable cavity. In some embodiments, the main housing 1 also includes a first front cover body 13, which is clamped with the first upper housing 11 and the first lower housing 12 respectively.

Specifically, in some embodiments, the main housing 1 also includes an inner support 14 detachably connected to the first upper housing 11 and provided with a control motherboard 152.

In some embodiments, the control motherboard 152 selects PCBA (printed circuit board assembly) to control motherboard.

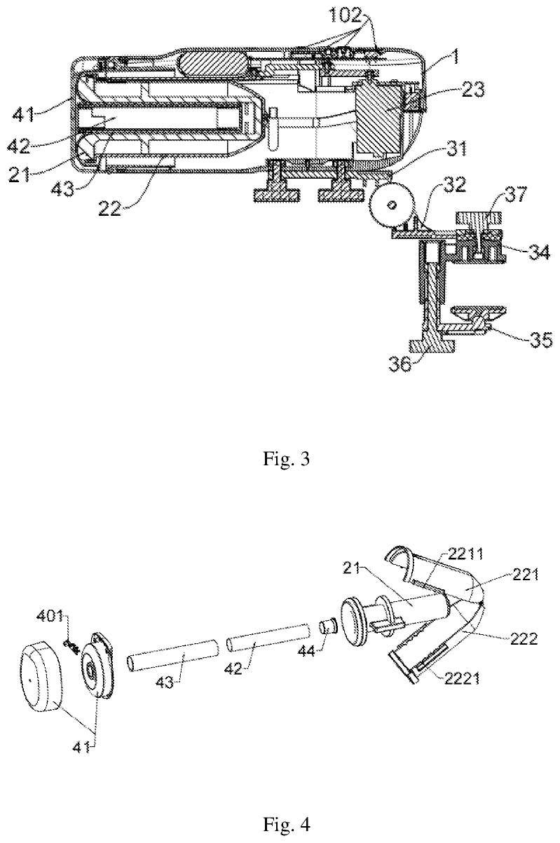

Specifically, in some embodiments, as shown in FIGS. 1 and 3, the outer support 4 includes an outer support plate 41. The heating part is connected to a side end of the outer support plate 41, and the outer support plate 41 is detachably connected to a side end of the main housing 1. That is, in the static state, it is buckled at a side end of the main housing through the outer support plate, and the heating part heats the massage body. When in use, the outer support plate is removed and the massage body with waste heat is used to massage the parts of the human body, thereby improving the operation flexibility and ensuring the service life between parts.

Specifically, in some embodiments, as shown in FIGS. 1, 2 and 5, the outer support 4 is provided with a charging input part 401. The main housing 1 is provided with a charging connection part 101 and a battery 151, an output end of the charging connection part 101 is electrically connected with an input end of the battery 151, and the battery 151 is configured to supply power to the massage body 2. An output end of the charging input part 401 is electrically connected with an input end of the charging connection part 101.

As shown in FIG. 5, the charging input part 401 is connected in the outer support plate 41.

The charging connection part 101 and the charging input part 401 both use conductive pins, thereby ensuring the power supply stability of the heating plate.

Specifically, in some embodiments, as shown in FIGS. 3 and 4, the heating part includes a heating sheet 42, a heat conducting rod 43 and a tail cover body 44. The tail cover body 44 is buckled at the other end of the heat conducting rod 43, the heating plate 42 is circumferentially connected to an inner surface of the heat conducting rod 43, and a side end of the heat conducting rod 43 is movable into the first movable cavity.

In some embodiments, the heating sheet 42 adopts an annular heating conducting sheet. The heat conducting rod 43 is made of aluminum. The aluminum heat conducting rod can achieve a certain waterproof effect, and improve the heating efficiency.

In some embodiments, the heating sheet 42 is provided with a temperature sensing resistance configured to sense and detect the temperature of the massage body 2.

In some embodiments, the first upper housing 11 is provided with a control plate 102 electrically connected with the control motherboard 152. The control plate 102 includes a temperature display screen and a control key. The temperature sensing resistance measures the temperature of the heating part in real time, and feeds back the temperature to the temperature display screen of the nixie tube to display the reading, and feeds back to the product chip to control the heating time to ensure that the temperature of the massage body is controlled within the suitable range of the human body.

Specifically, in some embodiments, as shown in FIGS. 3 and 4, the massage body 2 includes a massage inner pad 21, a placing housing 22 and a driving assembly 23, and the massage inner pad 21 is detachably connected inside the placing housing 22; the driving assembly 23 is located in the first movable cavity and movably connected with the placing housing 22, such that the placing housing 22 is movable from the first position to the second position, thereby improving the activity flexibility of the massage inner pad 21. In some embodiments, the massage inner pad 21 adopts the massage inner pad of soft rubber material to ensure the user's comfort. The massage inner pad 21 and the placing shell 22 are pushed by the sliding guide rail to move back and forth. The massage inner pad 21 rubs to massage the inserted human body instead of squeezing to massage.

Specifically, in some embodiments, as shown in FIG. 4, the placing housing 22 includes a second upper housing 221 and a second lower housing 222 hinged with each other, the second upper housing 221 and the second lower housing 222 forms a second placing inner cavity, and the first placing inner cavity is configured to place and mount the massage inner pad 21. A bottom of the second upper housing 221 is provided with an upper engaging body 2211, and a top of the second lower housing 222 is provided with a lower engaging body 2221 assembled with the upper engaging body 2211. The upper engaging body 2211 and the lower engaging body 2221 adopt the engaging structure of engaging gear teeth. Due to the tail hinge connection, an opening size of the second upper housing 221 and that of the second lower housing 222 can be adjusted to facilitate placing soft glue. At the same time, a structure for clamping the soft rubber is of toothed structure, which can effectively clamp the soft rubber and drive it to move back and forth.

Specifically, in some embodiments, as shown in FIG. 5, the driving assembly 23 includes a main driving motor 231, a pushing joint 26 and a traction assembly 24. The traction assembly 24 is connected with the placing housing 22. The main driving motor 231 is connected in the first movable cavity and movably connected with a first end of the pushing joint 26, and a second end of the pushing joint 26 is connected with a first end of the traction assembly 24. A second end of the traction assembly 24 is movably connected with the traction assembly 24 to enable the placing housing 22 to move from the first position to the second position, thereby improving the flexibility of the massage inner pad.

The main driving motor 231 can choose the reduction gearbox structure, which greatly enhances the output force and ensures that the sliding rail is not easy to be blocked when in use.

As shown in FIG. 5, the pushing joint 26 includes a first movable rod 232 and a second movable rod 233, a first end of the first movable rod 232 is movably connected with the main driving motor 231, a second end of the first movable rod 232 is movably connected with a first end of the second movable rod 233, and a second end of the second movable rod 233 is connected with the traction assembly 24.

In some embodiments, as shown in FIG. 5, the traction assembly 24 includes a sliding block 242, a sliding rail guide rod 243, a mounting cover body 241, a position information transmitting part and a position information receiving part; the mounting cover body 241 is provided with a first placing inner cavity, which is configured to mount the placing housing 22; the sliding rail guide rod 243 is connected in the main housing 1; a first end of the sliding block 242 is connected with the mounting cover body 241, and a second end of the sliding block 242 is slidably connected with the sliding rail guide rod 243; the position information transmitting part is connected in the sliding block 242; the position information receiving part is connected in the main housing 1. In some embodiments, the position information transmitting part adopts a magnetic ball structure, which can be slidably connected with a side wall of the sliding rail guide rod 243, thereby improving the flexibility and fluency of telescopic sliding. In some embodiments, the position information receiving part selects Hall sensor. When the sliding block drives the magnetic parts to move back and forth, the hall sensor will obtain the position of the magnetic parts to realize the adjustable telescopic stroke.

Specifically, in some embodiments, the driving assembly 23 also includes a connection assembly 25, and one end of the connection assembly 25 is movably connected with the pushing joint 26, and the other end of the connection assembly 25 is movably connected with the traction assembly 24.

In the first embodiment, as shown in FIG. 8, the connection assembly 25 includes a first connection block 2511, a first connection ball 2512, a second connection block 2513 and a first connection rod 2514; the first connection block 2511 is connected to the traction assembly 24, the first connection block 2511 is provided with a first connection hole, and an outer surface of the first connection block 2511 is provided with a first connection surface; the second connection block 2513 is connected with the pushing joint 26, and a second connection hole is provided in the second connection block 2513, and an inner wall of the second connection hole is provided with a second connection surface assembled with the first connection surface (that is, the second connection block 2513 is sleeved on an outer surface of the first connection block 2511 through the first connection surface and the second connection surface); the first connection ball 2512 is movably abutted against an inner wall of the first connection hole and the second connection hole; and the first connection rod 2514 passes through the first connection ball 2512 and is connected with the pushing joint 26.

The first connection surface and the second connection surface select thread surfaces matched with each other, thereby ensuring the stability of assembly and the convenience of disassembly and maintenance.

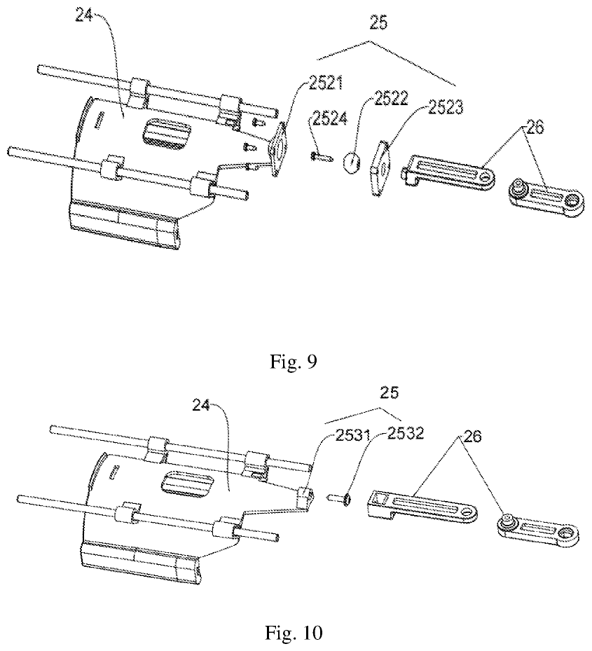

In the second embodiment, as shown in FIG. 9, the connection assembly 25 includes a first connection plate 2521, a second connection ball 2522, a second connection plate 2523 and a second connection rod 2524; the first connection plate 2521 is connected to the traction assembly 24, and the first connection plate 2521 is provided with a third connection hole; the second connection plate 2523 is provided with a fourth connection hole, and the second connection plate 2523 is detachably connected with the first connection plate 2521 through positioning bolts; the second connection ball 2522 is abutted against an inner wall of the fourth connection hole and an inner wall of the third connection hole, and the second connection rod 2524 passes through the second connection ball 2522 and is connected with the pushing joint 26, thereby ensuring the stability of assembly and the convenience of disassembly and maintenance.

In the second embodiment, as shown in FIG. 10, the connection assembly 25 includes a third connection block 2531 and a third connection rod 2532, the third connection block 2531 is connected to the traction assembly 24, and the third connection block 2531 is provided with a fifth connection hole; the pushing joint 26 is provided with a sixth connection hole; the third connection rod 2532 passes through the sixth connection hole and the fifth connection hole respectively, so as to make the traction assembly 24 to connect with the pushing joint 26, thereby ensuring the stability of assembly and the convenience of disassembly and maintenance.

In the second embodiment, as shown in FIG. 11, the connection assembly 25 includes a connection limit block 2541 and a fourth connection rod 2542; the connection limit block 2541 is provided with a C-shaped limit groove; the pushing joint 26 is provided with a first joint connection plate; the joint connection plate can be moved to the C-shaped limit groove, and the fourth connection rod 2542 passes through the first joint connection plate and the C-shaped limit groove respectively and is connected with the C-shaped limit groove and the first joint connection plate to make the traction assembly 24 to connect with the pushing joint 26, thereby ensuring the stability of assembly and the convenience of disassembly and maintenance.

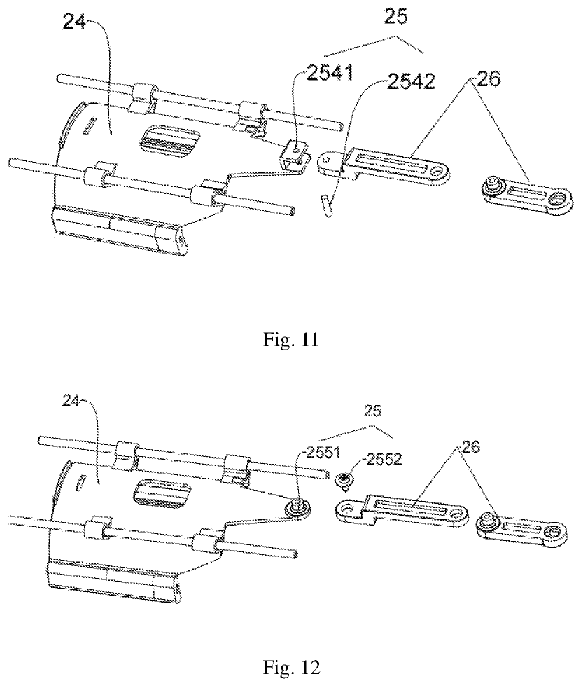

In the second embodiment, as shown in FIG. 12, the connection assembly 25 includes a connection limit column 2551 and a fifth connection rod 2552; the connection limit column 2551 is connected to the traction assembly 24, and the connection limit column 2551 is provided with a seventh connection hole; the pushing joint 26 is provided with a second joint connection plate, and the second joint connection plate is provided with a joint connection hole; the fifth connection rod 2552 passes through the joint connection hole and the seventh connection hole and is detachably connected with the connection limit column 2551 and the second joint connection plate, thereby ensuring the stability of assembly and the convenience of disassembly and maintenance.

Specifically, in some embodiments, as shown in FIGS. 1-3, 6 and 7, the human body massage device also includes a bottom support device 3; the bottom support device 3 is provided with a swing assembly and a locking assembly; the locking assembly is configured to connect with the base 5; a first end of the swing assembly is connected with the main housing 1, and a second end of the swing assembly is connected with the locking assembly, so that the main housing 1 can swing along the locking assembly. The positioning and fixing function is realized through the locking assembly, which can avoid handheld operation, so as to improve the operation flexibility; the swinging of the swing assembly can adapt to more different space environments and different people.

In some embodiments, as shown in FIG. 6, the swing assembly includes a first support swing plate 31, a second support plate 32 and a first locking part 33. A first end of the first support swing plate 31 is detachably connected with the main housing 1, and a second end of the first support swing plate 31 is swingably connected with a first end of the second support plate 32 in an up-down direction, a second end of the second support plate 32 is detachably connected with the locking assembly; when the first support swing plate 31 and the second support plate 32 are at the first threshold included angle, the first locking part 33 is locked with the first support swing plate 31 and the second support plate 32 respectively, thereby ensuring structural stability and swing flexibility. The first locking assembly 33 selects the locking bolt.

The locking assembly comprises a third support plate 34, a fourth support limit plate 35 and a second locking part 36, a first end of the third support plate 34 is detachably connected with the swing assembly; the fourth support limit plate 35 is connected below the third support plate 34; the third support plate 34 and the fourth support limit plate 35 form a locking cavity configured to connect with the base 5; the second locking part 36 is movably connected with the third support plate 34 and the fourth support limit plate 35 to adjust a volume of the locking cavity. The second locking part 36 selects the locking bolt.

In some embodiments, as shown in FIG. 6, a bottom of the third support plate 34 is provided with an upper gasket 341; an upper end of the fourth support limit plate 35 is provided with a lower gasket 352; and the upper gasket 341 and the lower gasket 352 are respectively located on the upper side of the locking cavity and the lower side of the locking cavity, such that it can reduce the friction between the locking assembly and the base and improve the locking performance.

In some embodiments, as shown in FIG. 6, an upper end of the fourth support limit plate 35 is also provided with a first adsorption 351, which is configured to suct and connect with the base 5. The first adsorption 351 adopts a spherical suction cup structure with a groove in the middle, such that it can realize the three-dimensional adjustment of the part surface, thereby ensuring that the part surface is completely consistent with a lower surface of the base to achieve the ideal clamping effect.

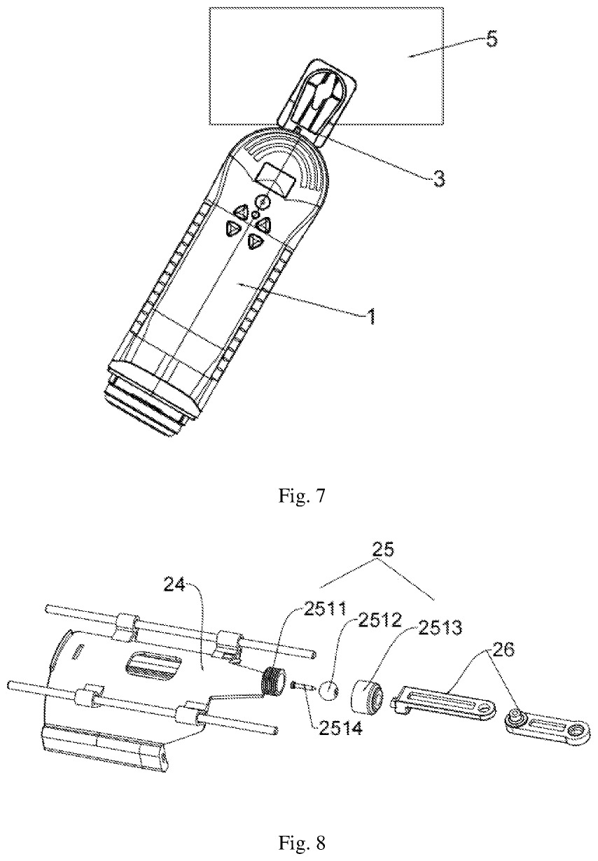

Due to a detachable connection between the locking assembly and the base, the bottom support device 3 can swing to the left and right for limit locking connection, as shown in FIG. 7, the human body massage device thus can swing left and right and rotate up and down, such that it can adapt to more different space environments and different people.

The above is only the preferred embodiment of the present application and does not limit the scope of the patent of the present application. Under the inventive concept of the present application, any equivalent structural transformation made by using the contents of the description and drawings of the present application, or directly/indirectly applied in other relevant technical fields, are included in the scope of patent protection of the present application.

1. A human body massage device, comprising:
a main housing provided with a first movable cavity;
a massage body movably connected in the first movable cavity, the massage body being movable from a first position of the first movable cavity to a second position of the first movable cavity along an axial direction of the main housing; and
an outer support provided with a heating part for conducting heat to the massage body.

2. The human body massage device according to claim 1, wherein the main housing comprises a first upper housing and a first lower housing detachably connected with each other; and the first upper housing and the first lower housing form the first movable cavity.

3. The human body massage device according to claim 1, wherein the outer support comprises an outer support plate, and the heating part is connected to a side end of the outer support plate; and the outer support plate is detachably connected to a side end of the main housing.

4. The human body massage device according to claim 3, wherein the outer support is provided with a charging input part; the main housing is provided with a charging connection part and a battery; an output end of the charging connection part is electrically connected with an input end of the battery, and the battery is configured to supply power to the massage body; and an output end of the charging input part is electrically connected with an input end of the charging connection part.

5. The human body massage device according to claim 1, wherein the heating part comprises a heating sheet and a heat conducting rod; the heating sheet is circumferentially connected to an inner surface of the heat conducting rod, and a side end of the heat conducting rod is movable into the first movable cavity.

6. The human body massage device according to claim 1, wherein the massage body comprises a massage inner pad, a placing housing and a driving assembly, and the massage inner pad is detachably connected inside the placing housing; and the driving assembly is located in the first movable cavity and movably connected with the placing housing, such that the placing housing is movable from a first position to a second position.

7. The human body massage device according to claim 6, wherein the driving assembly comprises a main driving motor, a pushing joint and a traction assembly; the traction assembly is connected with the placing housing; the main driving motor is connected in the first movable cavity and movably connected with a first end of the pushing joint, and a second end of the pushing joint is connected with a first end of the traction assembly; and a second end of the traction assembly is movably connected with the traction assembly.

8. The human body massage device according to claim 7, wherein the traction assembly comprises a sliding block, a sliding rail guide rod, a mounting cover body, a position information transmitting part and a position information receiving part; the mounting cover body is provided with a first placing inner cavity, and the first placing inner cavity is configured to mount the placing housing; the sliding rail guide rod is connected in the main housing; a first end of the sliding block is connected with the mounting cover body, and a second end of the sliding block is slidably connected with the sliding rail guide rod; the position information transmitting part is connected in the sliding block; and the position information receiving part is connected in the main housing.

9. The human body massage device according to claim 1, further comprising a bottom support device provided with a swing assembly and a locking assembly, wherein the locking assembly is configured to connect with a base; a first end of the swing assembly is connected with the main housing, and a second end of the swing assembly is connected with the locking assembly, so that the main housing is swingable along the locking assembly.

10. The human body massage device according to claim 9, wherein the swing assembly comprises a first support swing plate, a second support plate and a first locking assembly, a first end of the first support swing plate is detachably connected with the main housing, and a second end of the first support swing plate is swingably connected with a first end of the second support plate in an up-down direction; a second end of the second support plate is detachably connected with the locking assembly;
when the first support swing plate and the second support plate are at a first threshold included angle, the first locking assembly is locked with the first support swing plate and the second support plate respectively; and/or
the locking assembly comprises a third support plate, a fourth support limit plate and a second locking part; a first end of the third support plate is detachably connected with the swing assembly; the fourth support limit plate is connected below the third support plate, and the third support plate and the fourth support limit plate form a locking cavity configured to connect with the base; and the second locking part is movably connected with the third support plate and the fourth support limit plate respectively to adjust a volume of the locking cavity.

11. The human body massage device according to claim 6, wherein the massage inner pad is movable with the placing housing, and rubs to massage the human body inserted during movement.
